(19) United States
(12) Patent Application Publication
(10) Pub. No.: US 2025/0307243 A1
(43) Pub. Date: Oct. 2, 2025

(54) Unbounded Regular Path Queries In SQL

(71) Applicant: Oracle International Corporation, Redwood Shores, CA (US)

(72) Inventors: Hugo Kapp, Zurich (CH); Laurent Daynes, Saint-Ismier (FR); Vlad Ioan Haprian, Zurich (CH); Ioannis Alagiannis, Zurich (CH); Lei Sheng, Foster City, CA (US); Vasileios Trigonakis, Zurich (CH); Andrew Witkowski, Foster City, CA (US); Hassan Chafi, San Mateo, CA (US); Sungpack Hong, Palo Alto, CA (US)

(21) Appl. No.: 18/622,281

(22) Filed: Mar. 29, 2024

(51) Int. Cl. G06F 16/2453

(52) U.S. Cl. CPC G06F 16/24537

(57) ABSTRACT

A relational database system compiles and executes unbounded regular path queries (RPQs). A compilation stage splits the unbounded RPQ query in three portions: the prefix, the recursion, and the suffix. The compilation stage generates a relational execution tree. The recursive portion of the query is compiled using a specialized algorithm via an inline graph algorithm function (GAF) framework. The compilation stage generates a GAF node in the relational execution tree having a left child that is the specialized algorithm and a right child that is the suffix portion. The compilation stage generates a NESTED LOOPS join node in the relational execution tree having a left child that is the prefix portion and a right child that is the GAF node. The suffix portion uses results of the specialized algorithm. The values from the prefix portion and the suffix portion are concatenated by using the current semantics of NESTED LOOPS join.

### FIELD OF THE INVENTION

The present invention relates to compilation and execution of unbounded regular path queries in a relational database.

### BACKGROUND

Graph processing is an important tool for data analytics. Relational database management systems (RDBMSs) increasingly allow users to define property graphs from relational tables and to query property graphs using graph pattern matching queries. Most products limit users to defining a property graph out of a single vertex table and a single edge table (e.g., Microsoft SQL Server, SAP Hana). These graphs are called homogeneous graphs. The most advanced systems (e.g., IBM DB2) allow definition of a graph out of multiple vertex and edge tables, which is referred to as a “heterogeneous” graph. Generally, for heterogeneous graphs, every row from every vertex or edge table represents a vertex or edge, respectively. For example, one can create a heterogeneous graph out of the existing tables in a database by mapping every dimension table to a vertex table and every fact table to an edge table. Generally, vertex tables should have a primary key column, and edge tables should associate two foreign keys corresponding to the primary keys in one or more vertex tables.

Graph analytics includes graph querying and pattern matching, which enables interactive exploration of graphs in a manner similar to interactive exploration of relational data using Structured Query Language (SQL). Pattern matching refers to finding patterns in graph data that are homomorphic to a target pattern, such as a triangle. Similar to SQL, in addition to matching a structural pattern, pattern matching may involve projections, filters, etc. Property Graph Query (PGQ) is a query language for the property graph data model.

Graph analytics further includes graph algorithms. Graph algorithms analyze the structure of graph data, possibly together with properties of its vertices and/or edges, to compute metrics or subgraphs that help in understanding the global structure of the graph.

Unbounded regular path graph queries (usually shortened as “unbounded RPQs”) find paths in a graph that match a path pattern under a repetition operation. The repetition is determined by a quantifier, which includes a lower bound and an optional upper bound for the number of repetitions. Unbounded regular path queries have no upper bound, i.e., the pattern may be repeated an infinite number of times to generate a solution. Path modes are used to reduce the possibly infinite result set of such queries into a tractable, finite result set. Examples of path modes include SHORTEST (find the path with the least number of hops to the destination) and CHEAPEST (find the path with the lowest “cost,” where the cost is defined by an arbitrary positive expression over the path). Result paths can then be manipulated to answer questions about them, e.g., what are the values of vertex or edge properties along the paths.

The following example (Query 1) of an unbounded RPQ, written using SQL/PGQ syntax, finds, in a graph of cities connected by roads, a shortest path between the city named ‘Atlanta’ and each city in the state named ‘Missouri.’ The shortest path in this case is the one with the least number of city hops along the path. For each shortest path found to a valid destination city, the total distance of the path (e.g., in kilometers), the lowest speed limit along the roads traversed and the name of the destination city are returned.

Query 1

```
    SELECT *
FROM GRAPH_TABLE (
  roads_graph
  MATCH (c IS City) −[r]−>* (d IS City)
  KEEP ANY SHORTEST
  WHERE c.name = ‘Atlanta’ AND d.state = ‘Missouri’
  COLUMNS (SUM(r.distance) as tot_distance,
      MIN(r.speed_limit) as min_speed_limit,
      d.name as destination_city);
```

Unbounded RPQs are difficult to express in a relational setting due to their iterative nature and the unknown number of repetitions. Solutions using standard SQL constructs (e.g., RECURSIVE WITH) or general-purpose vendor-specific extensions to SQL (e.g. PL/SQL, T-SQL) are difficult to write, highly error prone, and do not provide adequate performance.

Unbounded RPQs form a very natural class of queries that can efficiently solve many real-world data querying problems. Examples of real-world use cases that need access to fast and scalable unbounded RPQs include money laundering detection, data provenance tracking and supply chain management. There is a need to compile and execute unbounded RPQs in an efficient and easy-to-write manner in a relational database system.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1A is a block diagram illustrating an operator tree for an unbounded RPQ in accordance with an illustrative embodiment.

FIG. 1B is a block diagram illustrating execution of a relational execution tree for an unbounded RPQ in accordance with an illustrative embodiment.

FIG. 2 illustrates an example of determining transitive closure based on prefix specializations in accordance with an illustrative embodiment.

FIG. 3 illustrates execution of an RPQ including joins between side tables and primary vertex tables for a heterogeneous graph in accordance with an illustrative embodiment.

FIG. 4 illustrates horizontal aggregations for an unbounded RPQ in accordance with an illustrative embodiment.

FIG. 5 illustrates building side tables with one row per step in accordance with an illustrative embodiment.

FIG. 6 is a block diagram illustrating an optimization for homogeneous graphs in accordance with an illustrative embodiment.

FIG. 7 is a flowchart illustrating operation of relational database system for compiling an unbounded RPQ to form a relational execution tree in accordance with an illustrative embodiment.

FIG. 8 is a flowchart illustrating operation of a relational database system for executing a relational execution tree for an unbounded RPQ in accordance with an illustrative embodiment.

FIG. 9 is a block diagram that illustrates a computer system upon which aspects of the illustrative embodiments may be implemented.

FIG. 10 is a block diagram of a basic software system that may be employed for controlling operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments efficiently compile and execute unbounded regular path queries in a relational database. This allows solving shortest and cheapest path queries, plain reachability queries, queries with regular path quantifiers, such as *, +, ?, {x, y}, and other types of unbounded RPQs. The illustrative embodiments include a compilation stage that splits the unbounded RPQ query in three portions: the prefix (the part of the path pattern before the repeated pattern), the recursion (the repeated part of the path pattern), and the suffix (the part of the path pattern after the repeated pattern). In the example Query 1 above, the prefix is (c IS City), the recursion is −[r]*, and the suffix is (d IS City). A system may add c.name=‘Atlanta’ in the prefix and d.state=‘Missouri’ in the suffix. The compilation stage generates a relational execution tree, also referred to as an execution plan or query plan.

The prefix and suffix portions are compiled using SQL/PGQ to SQL translation capabilities. The recursive portion of the query is compiled using a specialized algorithm via an inline graph algorithm function (GAF) framework. The compilation stage generates a GAF node in the relational execution tree. The left child of the GAF node is the specialized algorithm, and the right child of the GAF node is the suffix portion. In one embodiment, the specialized algorithm implements a one-to-many graph pattern matching algorithm. The specialized algorithm starts from the last vertex of the prefix subpath found by the prefix portion of the query.

The compilation stage generates a NESTED LOOPS join node in the relational execution tree. Compilation uses the NESTED LOOPS join to combine the prefix portion with the algorithm and suffix portions. The left child of the NESTED LOOPS join node is the prefix portion, and the right child of the NESTED LOOPS join node is the GAF node. The compilation stage compiles the suffix portion to use the results of the specialized algorithm, which will contain information about the destination and reaching paths. The values from the prefix portion and the suffix portion are concatenated by using the current semantics of NESTED LOOPS join.

In some embodiments, the compilation stage determines a set of prefix specializations for the prefix portion of the unbounded RPQ. The compilation stage determines a transitive closure of reachable vertex and edge tables for the set of prefix specializations and determines a set of suffix specializations for the suffix portion of the unbounded RPQ based on the transitive closure of reachable vertex and edge tables. The compilation stage translates the set of prefix specializations and the set of suffix specializations to SQL.

The illustrative embodiments, in an execution stage, execute the relational execution tree in an execution stage. The execution stage executes the prefix portion to generate a set of prefix result rows. Each row in the set of prefix result rows represents a pattern in the graph that matches the prefix portion of the unbounded RPQ. The execution stage executes the NESTED LOOPS join by fetching a row from the set of prefix result rows, calling the GAF node to execute the specialized algorithm, and executing the suffix portion of the unbounded RPQ. The specialized algorithm generates one or more side tables (e.g., cursor duration tables (CDTs)), and the suffix portion reads from the one or more side tables. In some embodiments, the suffix portion performs a join between a side table and a vertex table. The NESTED LOOPS join node performs a join of the row fetched from the set of prefix result rows and a set of result rows generated by the GAF node.

The illustrative embodiments enable fast, scalable, and memory controlled unbounded RPQ processing in a relational database system. The illustrative embodiments allow rewriting unbounded RPQs into a combination of SQL relational operators and a specialized graph algorithm processing operator, all to be executed in the same relational execution tree. The illustrative embodiments provide a compile-time processing phase that reduces, in a heterogeneous graph context, the set of data tables that must be traversed during the search graph algorithm, based on the label predicates in the unbounded RPQ. The relational execution tree uses a flexible graph algorithm processing operator, which permits many different graph algorithms to solve different kinds of RPQs (e.g., breadth-first search (BFS) for shortest, Dijkstra for cheapest). For shortest path queries, a BFS algorithm can be used in the graph algorithm processing operator, which works based on the subset of data mentioned above, reading the data from the relational database system, and which natively supports heterogeneous graphs. A combination of relational plan rewriting rules and graph search algorithm features support plain reachability queries and queries containing horizontal aggregations. The illustrative embodiments provide a combination of relational plan rewriting rules and graph search algorithm features that support queries that ask for more than one path per source-destination pair (e.g., top-k shortest).

The illustrative embodiments combine existing SQL operators and capabilities with well-defined semantics (specifically, NESTED LOOPs join and LATERAL semantics) in conjunction with new, specialized graph algorithm processing nodes in the same relational plan. The graph algorithm processing node is flexible, allowing the use of many traditional graph search algorithms (e.g., BFS for shortest, Dijkstra for cheapest) to solve different kinds of RPQs. This provides a simple way to express the iterative nature of shortest path and cheapest path queries in a SQL-friendly way, reusing existing SQL processing operators. Optimization of the execution tree in which this flexible graph algorithm node appears is handled by the pre-existing fine-tuned optimizer of the relational database system. By executing the entire query inside the relational database system, the solution avoids import/export into a separate specialized graph search engine, as is traditionally the way to compute these graph query workloads.

Furthermore, the illustrative embodiments include space and time optimizations, which, even though not necessary for correctness, can significantly improve the running time and space consumption of the solution. These optimizations include a way to process the repeated part in reverse order and heuristics to decide when this is expected to be more efficient, a way to bypass writing intermediate results to temporary storage when the graph is homogeneous, a way to improve the performance of neighbor expansions in BFS by expanding more than one vertex in the same SQL statement, a way to reuse previously computed algorithm results, a way to stop the computation of the RPQ kernel early based on constraints of the destination vertices, and a way to integrate multi-input search algorithms like Multi-Source BFS in the framework.

By integrating in the relational execution tree (query plan), the solution of the illustrative embodiments can reuse existing and very powerful SQL operators to perform many expensive operations. The illustrative embodiments can also continue processing RPQ results in any way that is supported by SQL with the data already stored in the relational system. Using a fairly unconstrained algorithm operator node allows express the iterative logic of the BFS algorithm necessary to solve shortest path queries to be easily expressed. It also provides an easy way to implement more advanced features, which would otherwise be very invasive and complex to implement in pure SQL. Further, the algorithm operator permits supporting multiple kinds of RPQ path modes, such as shortest path and cheapest path. Taken together, these elements nicely decouple the computation of the overall query between the purely recursive path section, computed by the algorithm, and the pre- and post-processing, done in regular SQL. The native support for heterogeneous graphs by using specializations prunes out computations that need not be performed at compile-time and reduces the data that must be processed at runtime to the minimum set of relevant vertex and edge tables. Executing these queries inside a relational system avoids some of the typical issues with exporting the data into a specialized graph search engine as is traditionally done for performance reasons. These typical issues include the time and computational overhead of data export and import, the security implications of exporting the data out of the relational system, and the need to redo the process when data updates are performed in the relational system.

The solution of the illustrative embodiments does not support pipelining of result paths. This means that results only start being pushed outside when the entire search algorithm is completed. As a consequence, the entire set of result paths (or the sufficient intermediate results to rebuild all of those paths) must be stored, and no part of it can be dropped until the algorithm completes. Considering the memory requirements of algorithms like BFS, this can lead to a very large memory consumption. The issue can be addressed by using external storage (e.g., disk), but at the cost of performance.

### SQL/PGQ

The illustrative embodiments use SQL/PGQ, which is a SQL standard extension for a graph querying language. With SQL/PGQ, graph pattern matching queries can be translated into SQL and given to the SQL engine of the relational database system for compilation, optimization, and execution. The translation process considers the heterogeneous nature of the graph (the graph may have any number of vertex and edge tables, which is determined by the graph schema), and the label expressions of the query.

The SQL/PGQ standard allows graph querying and pattern matching inside a SQL query, e.g., executed by a database server instance, but does not allow for execution of graph algorithms. SQL/PGQ also provides a way to declare property graphs on top of relational tables that act as vertex and edge tables. SQL/PGQ queries are identified by the GRAPH_TABLE operator in a SQL query.

An important aspect of the translation with respect to the illustrative embodiments is the concept of specializations. When translating a SQL/PGQ query into pure relational SQL, all the possible combinations of vertex and edge tables to which each path pattern variable may be associated are computed based on the graph schema and the label expressions. Each such possible combination is called a specialization. Once all the specializations have been determined, each one is translated into a SQL fragment containing the necessary joins between the various vertex and edge tables for this specialization. The results produced by these different SQL fragments are merged together using a SQL UNION ALL.

The SQL/PGQ extension and specializations are described in further detail below in “EFFICIENT COMPILATION OF GRAPH QUERIES ON TOP OF SQL BASED RELATIONAL ENGINE,” U.S. application Ser. No. 17/080,698, filed Oct. 26, 2020, now U.S. Pat. No. 11,567,932; “EFFICIENT COMPILATION OF GRAPH QUERIES INCLUDING COMPLEX EXPRESSIONS ON TOP OF SQL BASED RELATIONAL ENGINE,” U.S. application Ser. No. 17/080,700, filed Oct. 26, 2020; and, “EFFICIENT COMPILATION OF GRAPH QUERIES INVOLVING LONG GRAPH QUERY PATTERNS ON TOP OF SQL BASED RELATIONAL ENGINE,” U.S. application Ser. No. 17/080,719, filed Oct. 26, 2020, now U.S. Pat. No. 11,507,579, the entire contents of each of which are hereby incorporated by reference as if fully set forth herein.

### GAF

The illustrative embodiments also use a framework that extends the SQL/PGQ to SQL translation process described above and that allows computation of graph algorithms. This framework is referred to as Graph Algorithm Function (GAF). The GAF executes graph algorithms inside of the query. This is done by adding a new graph algorithm function (GAF) operator node in the relational execution tree of the query, which computes the algorithm and feeds its result to the rest of the SQL/PGQ query.

The Graph Algorithm Framework allows a user of a relational database management system (RDBMS) to declare a graph algorithm function (GAF) based on a GAF signature and GAF implementation, which define a graph algorithm that takes a property graph object as input and returns a logical graph object as output. Information for the GAF declaration is maintained in a database dictionary, which allows addition of GAFs without changing a kernel of the RDBMS. GAFs are used within graph queries to compute output properties of property graph objects, which are accessible in the enclosing graph pattern matching query as though they were part of the input graph object of the GAF. Temporary and output properties (referred to as “GAF-computed properties”) are live for the duration of the query cursor execution. According to various embodiments, a user includes, in the declaration of a GAF, a DESCRIBE function, used for semantic analysis of the GAF, and an EXECUTE function, which defines the operations performed by the GAF. Because GAFs take a graph object as input and return a logical graph object as output, it is possible to include multiple composite GAFs in a graph query. Composition of GAFs is done by supplying, as the input graph argument of an outer GAF, the result of an inner GAF.

At execution time, the entire graph algorithm, which is an arbitrarily complex computation over the graph, usually iterative, is executed before any rows are read from the part of the execution plan that corresponds to the translation of the graph pattern matching (SQL/PGQ). The algorithm computes values for each vertex and/or edge of the graph, called properties. The resulting property values are stored in Cursor Duration Temporary Tables (CDTs). The contents of these CDTs are then read by the SQL/PGQ side of the final query and joined with the corresponding graph vertex and edge tables.

The Graph Algorithm Framework (GAF) is described in further detail in “INLINE GRAPH ALGORITHM EXECUTION WITH A RELATIONAL SQL ENGINE,” U.S. application Ser. No. 17/584,262, filed Jan. 25, 2022, now U.S. Pat. No. 11,921,785, and “USING TEMPORARY TABLES TO STORE GRAPH ALGORITHM RESULTS FOR A RELATIONAL DATABASE MANAGEMENT SYSTEM,” U.S. application Ser. No. 17/585,146, filed Jan. 26, 2022, the entire contents of each of which are hereby incorporated by reference as if fully set forth herein.

### Unbounded Regular Path Queries

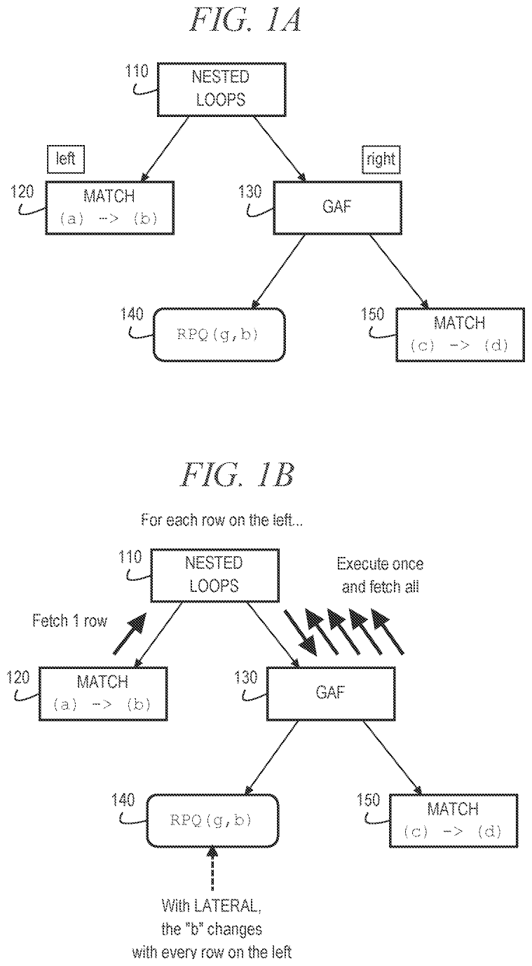

FIG. 1A is a block diagram illustrating compilation of a relational execution tree for an unbounded RPQ in accordance with an illustrative embodiment. The example shown in FIG. 1A is for the following query, Query 2:

Query 2

MATCH (a)−>(b)−>*(c)−>(d)

In Query 2, the recursive portion is ->*, the prefix is (a)->(b), and the suffix is (c)->(d). Query compilation parses as part of SQL/PGQ, semantically analyzing as part of SQL/PGQ, splitting into prefix 120, recursion, and suffix 150. Query compilation translates the prefix 120 into SQL (one of the outputs must be the vertices from which to start the recursion). In the example shown in FIG. 1A, the prefix matches the pattern (a)->(b). Query compilation then generates a GAF node 130 for the recursive portion of the query. Query compilation translates the suffix 150 into SQL (reading from the CDTs generated by GAF). In the example shown in FIG. 1A, the suffix matches the pattern (c)->(d). Query compilation generates a NESTED LOOPS join node 110 with the prefix 120 as the left child and the GAF node 130 and suffix 150 as the right child.

NESTED LOOPS is a type of join method. A NESTED LOOPS join determines the outer table that drives the join, and for every row in the outer table, probes each row in the inner table. The outer loop is for each row in the outer table and the inner loop is for each row in the inner table. An analogy from programming is a f or loop inside of another f or loop.

In the depicted example, GAF node 130 executes a recursive graph algorithm 140 (RPQ (g,b)), where g is the graph, and b is the vertex from the prefix from which the recursive patterns start.

FIG. 1B is a block diagram illustrating execution of a relational execution tree for an unbounded RPQ in accordance with an illustrative embodiment. The NESTED LOOPS join node 110 calls start on its left child, which is prefix 120. The NESTED LOOPS join node 110 fetches one row from its left child, prefix 120, and calls start on the right child, which is the GAF+suffix node 130. This triggers execution of the RPQ kernel algorithm 140 (GAF semantics). The starting vertex for the RPQ kernel algorithm 140 is taken from the current left child row of the NESTED LOOPS join node 110. The algorithm 140 fills one or more side tables (CDTs).

NESTED LOOPS join node 110 fetches all rows from its right child (GAF 130+suffix 150). These rows are read from the query suffix portion 150, and the GAF node 130 is ignored at this point. The suffix translation reads from the filled CDTs for path and destination information.

The NESTED LOOPS join node 110 then repeats the process for each row from the left child, and the algorithm 140 is re-executed for each row coming from the left child. With LATERAL semantics, the b in RPQ (g,b) changes with each row fetched from the prefix results.

These compilation and runtime (execution) steps are followed in the description below. FIGS. 1A and 1B illustrate a high-level architecture of the solution. Specifics of individual features design, and the changes they require to the various phases and components, will be described below. The example queries described herein use the SQL/PGQ standard syntax.

### Query Compilation

### Path Pattern Splitting

Compilation of the unbounded RPQ starts by splitting the query into a prefix portion, a recursive portion, and a suffix portion. The recursive portion of the query is the repeated part of the path pattern. Once the repeated part of the path pattern is identified, everything before (to the left of) the repeated part of the pattern is the prefix, and everything after (to the right of) the repeated part of the pattern is the suffix. As part of the splitting process, the compilation stage ensures that post-filters (i.e., predicates in the global WHERE clause of GRAPH_TABLE) are split appropriately. Predicates that only make use of path pattern variables declared in the prefix are moved to the prefix part of the split. The same applies for the suffix. For correctness reasons, post-filters that refer to repeated path variables cannot be pushed down inside the recursive part of the split. These postfilters must be executed after the search algorithm is completed. These predicates are pulled at the top-level and executed on the result of the join between the prefix and suffix.

More than one unbounded RPQs in a single path pattern matching are not discussed here. Supporting these only requires splitting the path pattern in more chunks. The suffix of one repeated path pattern is the prefix of the next one (from left to right).

### Specializations

Splitting the query into prefix, reachability algorithm, and suffix impacts the SQL/PGQ specializations. The compilation computes the specializations for the prefix. This follows the existing process. The output of this phase is a list of specialization trees that may end in different vertex tables. There is a UNION ALL of the prefix specializations.

Compilation then computes the subset of the graph that must be considered in the reachability algorithm. For each specialization tree of the prefix, compilation starts from the ending vertex table and computes the transitive closure of reachable vertex and edge tables. This transitive closure computation considers: the start vertex table (start vertex table for the algorithm, i.e., the end vertex table for the prefix specialization), the topology of the graph (which vertex tables are connected to which edge tables), the label constraints in the repeated path, and the direction of the repeated path pattern (outwards, inwards or any-directed).

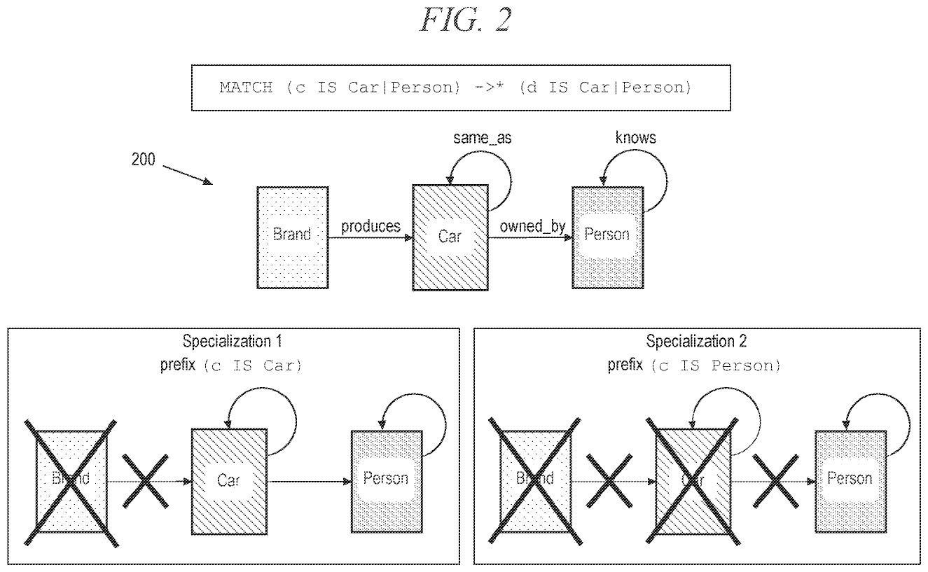

FIG. 2 illustrates an example of determining transitive closure based on prefix specializations in accordance with an illustrative embodiment. In the depicted example, the following query, Query 3, is applied against a graph with graph schema 200:

Query 3

MATCH (c IS Car|Person) −>* (d IS Car|Person)

In Query 2, the prefix is (c IS Car|Person), the recursive portion is ->*, and the suffix is (d IS Car|Person). Query 2 finds any path that starts at a vertex in the Car vertex table or Person vertex table and ends at a vertex in the Car vertex table or Person vertex table. In graph schema 200, a vertex in the Brand vertex table can have a produces relationship with a vertex in the Car vertex table, a vertex in the Car vertex table can have a same_as relationship with another vertex in the Car vertex table, a vertex in the Car vertex table can have an owned_by relationship with a vertex in the Person vertex table, and a vertex in the Person vertex table can have a knows relationship with a vertex in the Person vertex table. In the depicted example, the relationships are unidirectional.

The compilation stage generates two prefix specializations. In specialization 1, the prefix is (c IS Car). Therefore, a vertex from the prefix can reach a vertex in the Car vertex table through the same_as relationship or a vertex in the Person vertex table through the owned_by relationship. For specialization 1, a vertex in the Brand vertex table cannot be reached. In specialization 2, the prefix is (c IS Person). Therefore, a vertex from the prefix can reach a vertex in the Person vertex table through the knows relationship. For specialization 2, a vertex in the Brand vertex table or the Car vertex table cannot be reached. Consequently, the edge tables that go to these unreachable vertex tables are not useful and can be ignored when processing the recursion.

Each prefix specialization gets a different algorithm invocation. Each algorithm invocation is compiled and later run with the subset of the graph that was found reachable with this transitive closure computation. This will limit the number of CDTs allocated for that algorithm computation, as well as reduce the work that must be performed at runtime.

Based on the outcome of the transitive closure, the compilation stage also computes the specializations for the suffix. For each prefix specialization, the compilation stage applies the regular SQL/PGQ specialization process starting from the set of reachable vertex tables in the transitive closure. For the GAF node, the compilation stage also must generate the corresponding joins between the base vertex tables and the CDTs filled in by GAF (this is implemented for GAF compilation). If a given prefix specialization leads to no viable set of vertex or edge tables for the recursive portion and/or the suffix, then the specialization is dropped (no rows could ever be produced). Like the prefix specializations, there is a UNION ALL of the suffix specializations.

### Translation to SQL

The compilation stage translates the specializations to SQL with added GAF nodes. The process of translating specializations with added GAF nodes is described in further detail in “INLINE GRAPH ALGORITHM EXECUTION WITH A RELATIONAL SQL ENGINE,” U.S. application Ser. No. 17/584,262, referenced above. The compilation stage adds the NESTED LOOPS join node at the root (top) of the relational execution tree, between the prefix and the GAF node+suffix.

### Runtime

### NESTED LOOPS Semantics

NESTED LOOPS join starts the left child and fetches one row from the left child. NESTED LOOPS join then starts the right child (GAF node+suffix) and fetches all rows from the right child. NESTED LOOPS join then loops back to fetch the next row from the left child and repeats the process.

### LATERAL Semantics

LATERAL semantics allow referencing columns from the left child of the join in the right child. In the simplest cases, this is rewritten into a regular join (e.g., a hash join). In more complex cases, a NESTED LOOPS join is used such that the right child reads the value from the current row pulled by NESTED LOOPS from the left child.

### GAF Semantics

GAF semantics execute the specialized recursion algorithm upon the start of the GAF node. The algorithm fills in the side tables (CDTs), which are part of the SQL/PGQ translated child query. GAF semantics read from the SQL/PGQ translated query upon fetch. This eventually reads the content of the CDTs produced by the recursion algorithm.

Combining LATERAL NESTED LOOPS with GAF

A combined row-source tree is shown in FIG. 1A. The left child of NESTED LOOPS join node 110 is the SQL/PGQ prefix node 120, and the right child is the GAF node 130, which has the SQL/PGQ suffix node 150 (MATCH (c)->(d)) as its right child.

By combining NESTED LOOPS, LATERAL, and GAF, the following execution flow results:
1. NESTED LOOPS calls start on its left child (RPQ prefix MATCH (a)->(b)).
2. NESTED LOOPS fetches one row from its left child. This is the next pair (a), (b) that matches the RPQ prefix.
3. NESTED LOOPS calls start on its right child (GAF+suffix). This triggers the execution of the RPQ kernel algorithm (GAF semantics). The starting vertex is taken from the current left child row of the NESTED LOOPS node. This is the current pair (a), (b) that should be used to start the RPQ search. The algorithm fills the side tables (CDTs) and finds all reachable (c) with vertices starting from (b).
4. NESTED LOOPS fetches all rows from its right child (GAF+suffix). These are read from the RPQ suffix (GAF semantics). The GAF node is ignored here. The RPQ suffix translation reads from the filled CDTs. These CDTs contain information about the reachable destinations and the corresponding paths. The suffix finds the vertices (d) reachable from (c).
5. NESTED LOOPS continues at step 2 to fetch the next row from the left child. This moves to the next pair (a), (b) that matches the prefix.

Note that if the RPQ prefix, a.k.a. the left child of the NESTED LOOPS join, produces more than one row, then the GAF and suffix must be executed with a “clean slate.” That is, the CDTs must be truncated between the different executions of the shortest path kernel.

### How SOL/PGO Reads the Output Produced by the Algorithm

Following GAF semantics, the RPQ kernel writes its output to side tables (CDTs), with one such table per vertex table of the graph. The SQL/PGQ suffix then reads these values from the side tables, performing any necessary joins between these tables and the primary vertex and edge tables of the graph. These joins express the semantics of the RPQ suffix, which may include projections or filters that use property values from the primary vertex table, in which case a join between the side tables and their primary vertex table is performed.

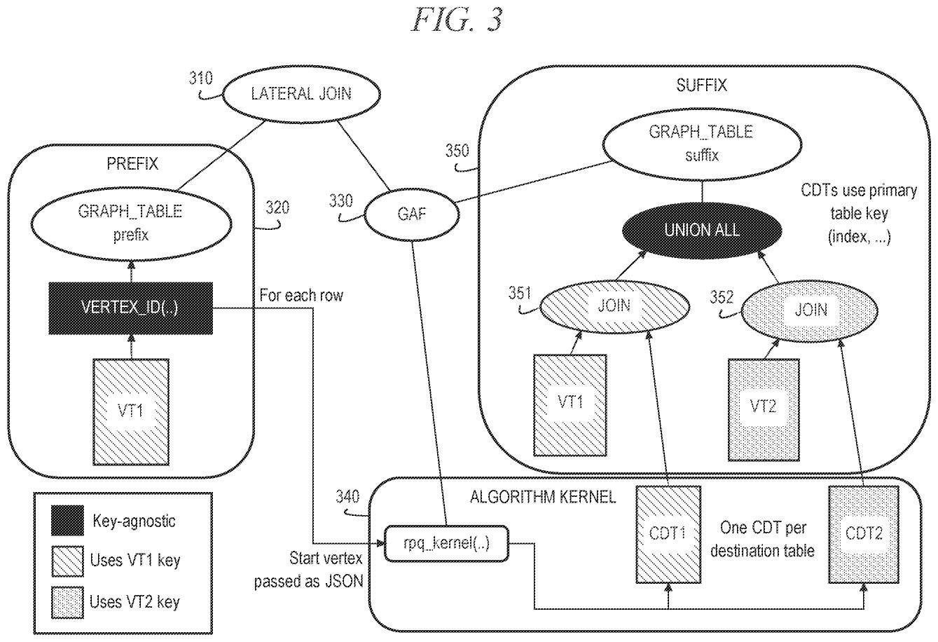

FIG. 3 illustrates execution of an RPQ including joins between side tables and primary vertex tables for a heterogeneous graph in accordance with an illustrative embodiment. In prefix 320, the GRAPH_TABLE operator can be used as a table expression in a FROM clause. It takes a graph as input against which it matches a specified graph pattern (from a prefix specialization). It then outputs a set of solutions in tabular form (prefix result rows). Individual rows in the table expression can then be fetched and provided to LATERAL JOIN 310.

The VERTEX_ID operator uniquely identifies a vertex in a SQL property graph. The input to the VERTEX_ID operator is a single vertex graph pattern variable coming from a matched vertex pattern. In the example shown in FIG. 3, VERTEX_ID identifies a vertex in vertex table VT1. The VERTEX_ID operator provides a start vertex from a row from the table expression to algorithm kernel 340. This start vertex is a vertex in VT1 from a pattern that matches the prefix portion of the RPQ. In one embodiment, the start vertex is passed to algorithm kernel 340 in the JSON format.

GAF 330 triggers algorithm kernel 340 to execute the recursive algorithm and generate side tables. In the depicted example, the graph is a heterogeneous graph, and the start vertex is from VT1. In one embodiment, the prefix 320 shown in FIG. 3 may correspond to specialization 1 shown in FIG. 2 such that VT1 corresponds to the Car vertex table and VT2 corresponds to the Person vertex table. Thus, in this example, the recursive pattern can reach vertices in the Car vertex table (VT1) or the Person vertex table (VT2). Algorithm kernel 340 executes the recursive algorithm and fills a CDT table for each vertex table, where CDT1 corresponds to VT1 and CDT2 corresponds to VT2.

Suffix 350 performs join 351 of VT1 and CDT1 and join 352 of VT2 and CDT2. Suffix 350 then performs a UNION ALL of join 351 and join 352. In suffix 350, the GRAPH_TABLE operator takes a graph as input against which it matches a specified graph pattern (from the suffix specialization) and outputs a set of solutions in tabular form (suffix result rows). LATERAL JOIN 310 joins the prefix result rows and the suffix result rows.

On the other hand, if the prefix 320 corresponded to specialization 2 shown in FIG. 2, then the recursive pattern can reach vertices in the Person vertex table (VT2) but not the Car vertex table (VT1). Algorithm kernel 340 would then execute the recursive algorithm and fill CDT2, which corresponds to VT2. Suffix 350 would then perform join 352 of VT2 and CDT2 but join 351 and the UNION ALL would not be necessary.

### Algorithm Output

Like other GAF algorithms, the RPQ kernel 340 communicates its results by storing results in side tables. Output side tables are for vertex tables, i.e., the algorithm stores its results in a vertex output property. The output is written per destination. This means that for each path that reaches a given destination vertex d, the algorithm will write path info in the output property for d. In other words, the path info will be written in the side table corresponding to d, with the primary key value of d.

On top of the primary key columns, side tables have extra columns storing information about the path hops. The actual per-hop information depends on the RPQ features used in the query. RPQ features describe the extra columns required in the side tables (if any). These requirements are gathered at compile-time and drive the creation of the side tables.

At the end of the algorithm, the side tables contain the necessary path information. For each vertex that is reached by a path, the side table contains at most one row with the primary key of the reached vertex, as well as additional path information. This side table is then joined with the corresponding necessary tables in the suffix.

### Algorithm Kernel

The following description illustrates how the reachability kernel works for the most basic case (KEEP ANY SHORTEST, no aggregations, no filters). The impact of more advanced features on the kernel implementation is discussed below. In some embodiments, such as the KEEP ANY SHORTEST query example, the algorithm implemented in the RPQ kernel is a simple breadth first search (BFS) algorithm that starts from a single source and discovers all the reachable destinations.

### Algorithm Arguments

Like other GAFs, the RPQ kernel takes as argument the graph metadata, which comprises a list of vertex and edge tables that compose the graph, what the key columns are, etc. In addition to the graph metadata, the RPQ kernel also takes as arguments the start index, which is passed as a JSON vertex_id in one embodiment, and metadata about the output CDTs. Each feature used in the original SQL/PGQ query may affect the number of property columns in these CDTs.

### Neighbor Expansion

The algorithm kernel uses SQL queries for graph traversals, e.g., to expand the neighbors of a given vertex. How the kernel deals with neighbor expansion in a heterogeneous environment is described below. For single edge table case, the following query, Query 4, represents a template for finding the neighbors of a vertex (a.k.a., vertex expansion):

Query 4

```
    SELECT dst.id
FROM vt1 src, et12 e, vt2 dst
WHERE src.id = :x
  AND src.join key = e.src_key
  AND dst.join key = e.dst_key;
```

This SQL template includes the following parts:
Bind variable: The vertex to be expanded is passed in this query as a bind variable. In the template, the bind variable is ‘:x.’ This bind variable is assigned the primary key value of the vertex to expand.
Multi-column keys: In the general case, any key in the CREATE PROPERTY GRAPH DDL may use more than one column. For the sake of simplicity, the template above shows all keys as single columns. The generalization to multi-column keys is trivial. In case the primary key of the vertex to be expanded spans multiple columns, the template also generates more than one bind variable, e.g., src.id1=x1 AND src.id2=:x2.

### Support for Heterogeneous Graphs

Homogeneous graphs have exactly one vertex and edge table. Heterogeneous graphs are more general and can have any number of vertex and edge tables.

### Unambiguous Key Format

In a general heterogeneous graph, vertices may come from different vertex tables. As a consequence, the number of columns in the primary key of these vertices, and the types of these columns, may not be the same for vertices coming from different vertex tables. To represent vertices in an unambiguous format, the unbounded RPQ compilation and execution of the illustrative embodiments use a compact binary format for the primary key values and a vertex table identifier for disambiguation. The compact binary format for the primary key values can represent any number of SQL values of any data type. Taken together, these two pieces of information indicate to which vertex table a vertex belongs and what its key value is.

### Heterogeneous Expansion

In a heterogeneous graph, a given vertex table may be connected to more than one edge table. When expanding vertices (i.e., finding their neighbors), one query is issued per outgoing edge table. These edge tables are the ones connected to the vertex table of the current vertex being expanded. In each of these queries, the edge table join columns will differ, and the destination vertex table keys may differ. The graph metadata is passed as an argument to the algorithm to build these queries.

### Label Predicates

Some embodiments provide support for label predicates in the repeated pattern, e.g., (a)-[e IS L2]*(b) or (a) ((x) (y IS L3))*(b). Label predicates for the start or end vertex (i.e., (a) and (b) in the example above) are not covered here but are supported. Such label expressions are simply handled by the SQL/PGQ to SQL translation process.

Label predicates in the repeated pattern restrict the set of vertex-edge-vertex relationships that can be traversed at the graph element table level. Triplets of vertex-edge-vertex tables that fail to match any of the label predicates (either on the source vertex, edge, or destination vertex) will never be used during the reachability exploration. As such, these triplets can be removed safely from the graph.

Label predicates in the repeated pattern are processed by restricting the graph metadata passed to the reachability kernel. This means that the graph metadata passed to the algorithm is a subset of the original graph object. Only triplets that match the label predicates are kept in the graph metadata. The filtering is based on edge tables. An algorithm to perform this filtering could be the following:
1. Iterate over the edge tables of the graph object. For each edge table, consider the triplet of source-edge-destination tables it describes.
2. Apply the label predicates. Keep the triplet only if each of its elements satisfies the corresponding label predicates. That is, the source vertex table must satisfy the source vertex label predicate, the edge table must satisfy the edge label predicate, and so on.
3. Once the set of edge tables necessary for the reachability query have been determined, the necessary vertex tables are trivially determined by looking at the source and destination vertex table of each of these edge tables.

### Disconnect Between the Start Vertex and the Subset of Vertex Tables

Depending on the label predicates and the specializations of the SQL/PGQ compilation, it could happen that the start vertex passed to the algorithm (remember that it is passed as JSON) does not belong to any of the vertex tables in the subset of the graph metadata passed to the algorithm. In this case, we know at compile-time that the RPQ kernel cannot find any reachable destinations. The entire specialization can be rewritten accordingly.

### Pre-Filters

Pre-filters are evaluated during the BFS expansion. They can affect both repeated vertices and edges. The following query, Query 5, represents an example of pre-filters:

Query 5

-- 1. Edge pre-filter
(a)-[e WHERE e.cost < 999]−>*(b)
-- 2. Vertex pre-filter
(a)(( )−>(x WHERE x.age < 30))*(b)

Pre-filters are semantically analyzed and compiled separately. For each vertex or edge table to which the referenced path pattern variable may be bound, a different SQL/PGQ rewrite is performed (note that properties do not necessarily map to a column of the same name in the underlying table and may be declared as expressions. these definitions can differ from table to table). These different compiled rewrites are passed to the algorithm kernel as part of the graph metadata argument.

When expanding neighbors, the rewritten filter corresponding to the triplet source-edge-destination tables under consideration is added to the neighbor expansion query. The following query, Query 6, represents a neighbor expansion template with pre-filter:

Query 6

```
    SELECT dst.id
FROM vt1 src, et12 e, vt2 dst
WHERE src.id = :x
  AND src.join_key = e.src_key
  AND dst.join_key = e.dst_key
  AND <rewritten pre filter for (src, e, dst)>;
```

### Horizontal Aggregations

Horizontal aggregations follow the high-level idea of “gather in the kernel, aggregate outside”:
1. The RPQ kernel gathers, during its BFS traversal, the property values of the vertices and edges along the paths. Only values for the properties that are used in aggregations in the original queries are gathered. This process can be seen as “early materialization.”
2. The result of the RPQ kernel, stored in CDTs, is then aggregated by the RPQ suffix. The aggregation is thus performed in SQL, and not in the kernel.

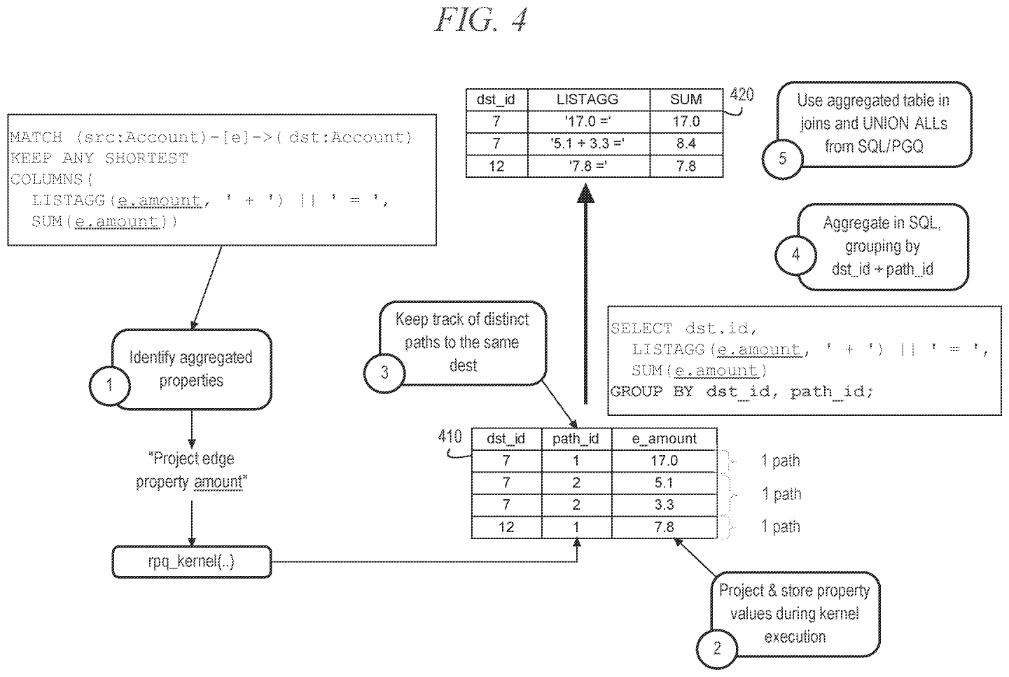

FIG. 4 illustrates horizontal aggregations for an unbounded RPQ in accordance with an illustrative embodiment. The following query, Query 7, represents an unbounded RPQ with horizontal aggregations:

Query 7

```
MATCH (src:Account)−[e]−>(dst:Account)
KEEP ANY SHORTEST
COLUMNS(
  LISTAGG(e.amount, ‘ + ’) || ‘ = ’,
  SUM(e.amount))
```

In step 1, aggregated properties are identified from the query. In the depicted example, the aggregated property is from SUM (e.amount). The edge property amount is projected to the RPQ kernel. The RPQ kernel builds CDT 410. In step 2, the RPQ kernel projects and stores the property values during kernel execution.

Step 3 keeps track of distinct paths to the same destination. This is necessary to support top-k type queries (e.g., top-k shortest or top-k cheapest), as well as keep all shortest or keep all cheapest queries. As seen in FIG. 4, for dst_id=7, there is one path with path_id=1 and one hop and one path path_id=2 and two hops. For dst_id=12, there is one path with path_id=1 and one hop. Thus, for the path having dst=7 and path_id=2, the aggregation must add the e.amount values for the two hops.

In step 4, the suffix aggregates the property values in SQL, grouping by dst_id and path_id. The following query, Query 8, represents this aggregation in SQL:

Query 8

```
SELECT dst.id,
  LISTAGG (e.amount, ‘ + ’) || ‘ = ’,
  SUM(e.amount)
GROUP BY dst_id, path_id;
```

As seen in Query 8, the aggregation is built in text (LISTAGG) and applied to generate the SUM in table 420. In step 5, the aggregated table 420 is used in joins and UNION ALLs from SQL/PGQ.

### Semantic Analysis

During semantic analysis, aggregations in the COLUMNS clause are identified. The property accesses on repeated path pattern variables in these aggregations are then collected. These property accesses are deduplicated to reduce space usage at runtime (example: in COLUMNS(SUM(e.cost), MAX (e.cost), SUM(v.age)), only e.cost and v.age are kept). The property accesses (i.e., repeated path pattern variable+property) that must be gathered during the BFS algorithm are passed to the GAF runtime as arguments.

### Gather in the Kernel

During neighbor expansion, the necessary property accesses are evaluated and the corresponding values stored as part of the path information. The evaluation of the property accesses is done by adding them to the neighbor expansion template. The following query, Query 9, represents a neighbor expansion template with property accesses:

Query 9

```
    SELECT dst.id, <property accesses>
FROM vt1 src, et12 e, vt2 dst
WHERE src.id = :x
  AND src.join_key = e.src_key
  AND dst.join_key = e.dst_key;
```

The resulting property values are collected and stored as part of the path hop information. When aggregations are present, a path is then represented as the last vertex reached in that path and a list of hops. Each hop contains property values for each property access that must be gathered by the RPQ kernel. A system may take advantage of the fact that many hop sequences will be shared among different paths to reduce its space consumption. Paths are what are used and stored in the BFS frontier queue. The visited set still only uses vertices.

### Output One Row per Step

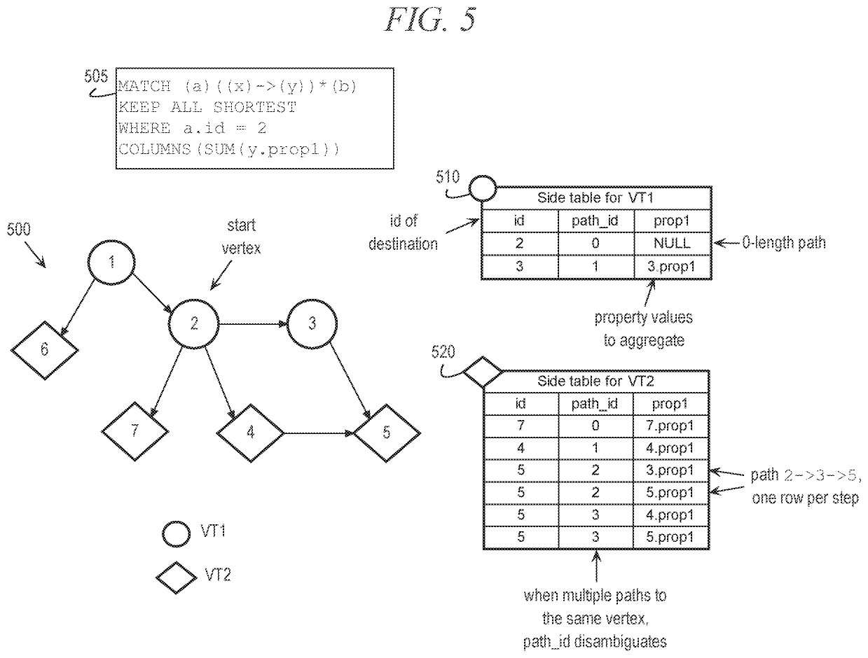

FIG. 5 illustrates building side tables with one row per step in accordance with an illustrative embodiment. In the depicted example, the input query 505 is an unbounded RPQ, represented as Query 10 as follows:

Query 10

MATCH (a)((x)−>(y))*(b)
KEEP ALL SHORTEST
WHERE a.id = 2
COLUMNS(SUM(y.prop1))

The query 505 is executed against graph 500, which has vertices 1, 2, and 3 from vertex table VT1 and vertices 1, 2, 4, 5 from vertex table VT2. The start vertex is vertex 2 from vT1. The path info is written in one-row-per-step form in the side tables 510, 520. That is, for each path reaching destination vertex d, the algorithm writes in the side table r entries for d, where r is the number of hops for that path.

Each vertex may be assigned 0 or more entries: 0 entries if the vertex is never reached by any path starting from the source vertex and one or more entries if any path reaches that vertex. The number of entries in the latter case is the sum of the number of hops for each path reaching that vertex, e.g., if the final paths are 2 3 5 and 2 4 5, then vertex 5 will have 2+2=4 rows in its side table, CDT 520, after the algorithm completes. For paths of length 0 (i.e., (a) is a solution to the RPQ), the algorithm writes one row in the side table, but with NULL values for all other columns of the side table other than the primary key columns.

For each step of the path, the row in the CDT contains the following information:
The PK of the destination vertex. This is the identifier for the final destination vertex of the path. That is, this PK value is replicated in every row stored in the CDT for that particular path.
The property values for the vertices and edges at this step. Because a step always consists of a source vertex, an edge, and a destination vertex.

The properties coming from either of the step elements can all be stored in the same row.

When there are multiple paths to the same destination vertex, path_id disambiguates. As shown in FIG. 5, there are four rows for destination ID 5, two rows with path_id=2 and two rows with path_id=3. For path_id=2, the property values 3.prop1 and 5.prop1 are aggregated, and for path_id=3, the property values 4.prop1 and 5.prop1 are aggregated.

### Aggregate in SQL

When the algorithm completes and has written its entire output to the CDTs, the SQL/PGQ suffix begins executing. The SQL/PGQ suffix is generated with the aggregations from the original RPQ. These aggregations are performed with a GROUP BY clause on the primary key columns and the path_id columns. This ensures that, when processing KEEP ALL SHORTEST or KEEP SHORTEST k, the values being aggregated all relate to the same path. When processing a KEEP ANY SHORTEST query, this ensures that the values being aggregated all relate to the same path. In other words, all the steps within a path leading to the same destination vertex are aggregated together. The following query, Query 11, represents an example suffix rewrite for aggregations:

Query 11

```
    SELECT SUM(prop1)
FROM CDT1
GROUP BY id1, path_id
  UNION ALL
SELECT SUM(prop1)
FROM CDT2
GROUP BY id2, path_id;
```

### Special Case: 0-Length Paths

Most SQL aggregations return NULL when applied to an empty set, but not all. In some embodiments, the aggregations must be performed to ensure that the correct aggregation value for 0-length paths is returned. To notify that a given vertex is reachable by following a path of length 0, the RPQ kernel writes a single row in the CDT for that vertex, with NULL as the value for all entries corresponding to properties. Without modification to the system described above for aggregations, this way of formatting the output already guarantees that the SQL aggregation returns the correct result, as it will be applied to a set containing a single NULL value.

### Plain Reachability

Techniques to represent the result of the RPQ algorithm kernel when doing aggregations are described above. Queries that do not compute aggregations cannot inspect the properties of the vertices and edges along the path in any way (this is not allowed by the SQL/PGQ standard under one-row-per-path semantics described above). For those queries, the RPQ kernel can be modified to write one row per path in the CDTs instead of one row per step. The inserted row only contains the primary key of the vertex reached. This generates less data than the intermediate one row per step format generated by the aggregation case and performs better as it does not involve a GROUP BY aggregation.

This more efficient one-row-per-path output for the RPQ kernel can be generalized to any aggregation that can be computed trivially inside the kernel. Depending on the system, this may include sums, products, BINDING_COUNT (·) (counting the number of hops in the path), etc. Considering the number of SQL datatypes and aggregations, re-implementing all of these aggregations inside the RPQ kernel to benefit from this improvement seems too much work for any system implementation; hence the general case laid out above.

### Top-K Shortest and KEEP ALL SHORTEST

Queries that ask for the top-K shortest paths, or for all of the equivalently shortest paths (KEEP ALL SHORTEST) can be supported with the architecture described above with minimal changes. Both top-K and KEEP ALL SHORTEST queries are discussed together as the set of necessary changes are very similar.

### New GAF Argument

The RPQ kernel must now take an extra argument that indicates whether top-K or ALL SHORTEST is requested. In the case of top-K, the value of k must also be passed to the algorithm at runtime.

### Modifications to the BFS Algorithm

Strategies for modifications required to turn a regular BFS algorithm into top-K or ALL SHORTEST are described below.

For top-K shortest, the visited set must be replaced by a hash map. That data structure must map each vertex to the number of times it has been visited so far. When checking whether or not to expand a vertex, the algorithm retrieves the corresponding “visited so far” value from the map and compares it with the value of k. If the vertex has been reached less than k times so far, then the vertex is expanded and the value in the hash map is increased by one. If the vertex has been reached at least k times, then the vertex is not expanded, and the current path is not written as a final result in the CDT.

For all shortest, the visited set can be replaced by a hash map. That data structure must map each vertex to the BFS level at which it has been visited. The BFS algorithm examines the hash map that maps each vertex to a BFS level at which the vertex has been visited. When checking whether or not to expand a vertex, the algorithm retrieves the corresponding “visited at level” value from the map. Then:
If there is no such entry in the map, the vertex has not been visited yet. A new entry mapping the current vertex to the current BFS level is inserted. The vertex is expanded.
If the value retrieved from the map is equal to the current BFS level, then the vertex is expanded.
If the value retrieved from the map is less than the current BFS level, then the vertex is not expanded, and the current path is not written as a final result in the CDT.

### Path Disambiguation

Top-k shortest and ALL SHORTEST queries can return more than one path per destination vertex. When performing aggregations, the values along the path must be aggregated per path. This is done using a path disambiguation value, a “path id.” After semantic analysis, an extra column is added to the CDTs for this path id. When writing the results to the CDTs, the RPQ kernel writes in this extra column a value that is different for each path. It should be trivial to have such a unique identifier for each path in any system. The GROUP BY aggregation that ensues is then performed by grouping by this path id rather than by primary key (as illustrated above with respect to horizontal aggregations). This guarantees that aggregations are performed per path.

### Cheapest Path

The architecture described in this document can support variants to the traditional SHORTEST PATH BFS algorithm. The most common such variant is for CHEAPEST PATH queries. CHEAPEST PATH queries specify the cost to be minimized along the path. SHORTEST PATH queries are a special case of CHEAPEST PATH where the cost is 1 for every edge. CHEAPEST PATH queries can be supported with the architecture described above by changing the algorithm kernel used. An algorithm for CHEAPEST PATH is not described here, but this is a problem with many efficient implementations. Other variants of unbounded path finding queries can be implemented by changing the algorithm kernel used in the design presented here.

### Improvements and Optimizations

There are a number of optimizations that can be implemented to improve the performance of the system described above. These are not necessary for correctness but improve the runtime performance and/or space consumption of the system.

### Reversed Path Processing

A shortest path query (a)->*(b) may be cheaper to compute as (b)<-*(a). This is typically true when (b) has a selective filter but (a) does not. It may be true in other scenarios. A system may use an appropriate heuristic to cost these alternatives and decide to process the recursive part in the reverse order. One way is to use existing optimizer capabilities of the enclosing relational database system to estimate the cardinality of the prefix and suffix. Cardinality estimation is a classical operation in relational optimizers. Based on the resulting estimates, the side with the lowest cardinality may be picked as prefix, as it will incur the lowest number of executions of the (rather expensive) graph algorithm.

If the decision to process the pattern in the reverse order is taken, then the following must be done:
The prefix is now what was on the right of the recursive pattern, and the suffix what was on the left.
The prefix (e.g., (b)->(x)->(y)) must be reversed (e.g., (y)<-(x)<-(b)).
The suffix (e.g., (v)->(w)->(a)) must be reversed (e.g., (a)<-(w)<-(v)).
The graph metadata passed to the graph algorithm kernel must be reversed. Every triplet (source vertex table V, edge table E, destination vertex table W) must be replaced with (source vertex table W, edge table E, destination vertex table V).

### Specialized Row-Source for the Homogeneous Case

Practical performance experiments show that a large part of the RPQ kernel's time is spent writing the final results to CDTs. In the general case, writing into the CDTs cannot be avoided. This is due to the heterogeneous nature of the graph algorithms supported. The algorithm must produce results for potentially many different vertex tables. In some particular implementations, there is currently no support for row-sources that produce values piped into different parent row-sources. Other implementations may not have this restriction. Hence CDTs are used to perform this dispatching properly.

In the special case of homogeneous graphs, this can be avoided. The graph algorithm row-source can be turned into a regular row-source producing homogeneous data. This specialized row-source can replace the CDT scan in the SQL/PGQ suffix, removing the need for CDTs altogether.

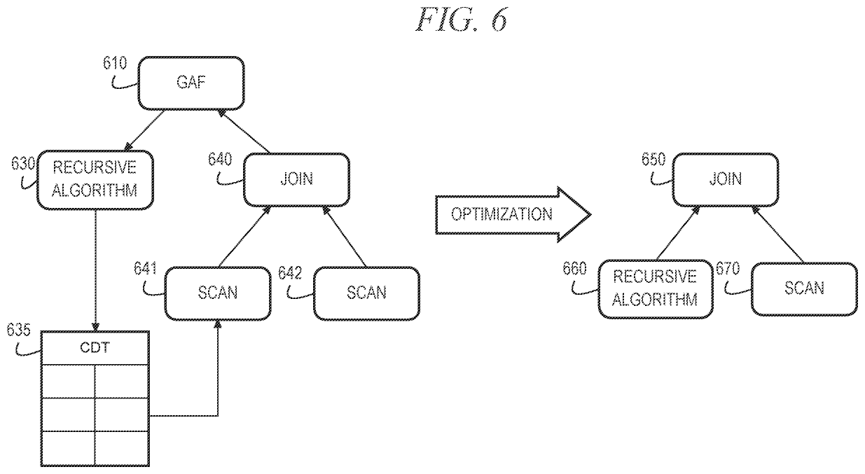

FIG. 6 is a block diagram illustrating an optimization for homogeneous graphs in accordance with an illustrative embodiment. For the general case, GAF node 610 calls recursive algorithm 630, which fills a CDT 635. There is then a scan 641 of the CDT 635 and a scan 642 of a vertex table. A join 640 of the CDT scan 641 and the vertex table scan 642 returns results to the GAF 610. After the optimization for homogeneous graphs, the modified recursive algorithm 660 is a row-source, and a join 650 combines the modified recursive algorithm row-source 660 and a scan 670 of the vertex table. There is no need to fill and then scan a CDT for the homogeneous case.

The number of vertex and edge tables in the graph cannot be controlled. However, the special case of unbounded RPQs is more likely to be in this homogeneous case for the RPQ kernel. This is due to the fact that the set of vertex and edge tables considered during the shortest path search is restricted by the label expressions in the repeated path pattern and the current prefix specialization. Note that there is one GAF node per specialization of the prefix. With these extra constraints and considering how users are expected to typically use unbounded RPQs in practice (i.e., using label expressions extensively), one can expect this homogeneous case to arise quite often for unbounded RPQs. This means that this optimization would be quite beneficial for unbounded RPQs.

Furthermore, the RPQ kernel is well-suited to be turned into a row-source. The algorithm it runs generates partial results while it runs. These partial results are known to be final. That is, the final result will necessarily be a superset of these partial results. Any partial result can therefore be pushed out as a row produced by this row-source. These partial results are the shortest paths. At each BFS level, paths for vertices not visited in a previous level are shortest path and can be produced as rows generated by this row-source. For top-k shortest path queries, shortest paths are paths for vertices that have been reached less than k times so far.

The engineering effort required to implement this optimization requires:
1. determining when to perform it,
2. modify the SQL/PGQ rewrite of the enclosing query,
3. introduce a new row-source,
4. avoid allocation of CDTs entirely,
5. modify the RPQ kernel to also work in “pull” mode, i.e., generate these partial results when asked.

### Batch Expand

The vertex expansion strategy described above uses a simple expansion scheme that issues one SQL query per vertex. This can be made more efficient by expanding more than one vertex in each query. This requires two modifications to the algorithm described previously. First, vertices in the current level of the BFS frontier must be grouped together. While doing this, care must be taken to avoid expanding a vertex twice. This can be done by adding the vertices to the visited set as they are being grouped.

Second, the neighbor expansion template must be modified. It must accept more than one input vertex and keep track of the mapping from expanded neighbor to input vertex. Each relational system may have its own efficient way of doing this, but in standard SQL, this can be achieved by modifying the template according to the following query, Query 12, which represents a batch neighbor expansion template:

Query 12

```
      WITH batch AS (
    SELECT 1 as index, :1 as key_value
    FROM DUAL
  UNION ALL
    SELECT 2 as index, :2 as key_value
    FROM DUAL
  UNION ALL
    ...
)
SELECT batch.index, dst.id
FROM batch, vt1 src, et12 e, vt2 dst
WHERE src.id = batch.key_value
  AND src.join_key = e.src_key
  AND dst.join_key = e.dst_key;
```

The batch.index value is used, when retrieving the results from the batch neighbor expansion, to properly route each neighbor to its corresponding path prefix that it now extends.

### Caching and Reuse of BFS Results

If the prefix of a RPQ produces the same vertex more than once as start point for the reachability part of the path pattern, the BFS result can be cached and reused. The most efficient way to do this is to add an ORDER BY clause in the prefix subquery. This guarantees that if the same vertex appears more than once, it will re-appear immediately after its first occurrence. This makes the cache very simple to implement by simply keeping track of the last BFS result plus the last start vertex.

### Early Stop Based on Destination Vertices

By default, BFS runs until either the max number of hops is reached (if one is provided) or if the frontier becomes empty. This means that the algorithm attempts to discover all the reachable destinations before stopping. This can be suboptimal in the case when the set of possible destinations is small, or potentially just one vertex. In these cases, it would be beneficial for the algorithm to stop when all the destinations of interest have been reached.

To improve this situation, it is possible to pass information to the BFS kernel about the set of possible destinations, based on information present in the original query. With this information, the algorithm can stop early if all the vertices in that set of possible destinations have already been reached. This can help reduce the running time of the search kernel drastically. The more restrictive the filters, the more gains from this optimization. As such, the best case for this optimization is when the RPQ is performing a single-source, single-destination search. In this case, the algorithm can stop as soon as it has found a shortest path to this single destination vertex.

The set of relevant destinations can be determined based on the label constraints of the destination vertex and the property constraints of the destination vertex. For example, for MATCH (a)->*(b IS Person), all the vertex tables may be traversed during the BFS search, but the search can stop as soon as one path to every vertex in Person is found. If Person is small compared to the rest of the graph, this can save a lot of computation. As another example, for MATCH (a)->*(b WHERE b.ssn=1234567), the search can stop as soon as one path to a vertex with b.ssn=1234567 is found.

### Multi-Source BFS

The architecture uses a single source BFS algorithm; however, the architecture can be extended to use a multiple source BFS (MS-BFS). Using MS-BFS can be more efficient. To support this, multiple vertices must be fetched from the left side of the NESTED LOOPS join that can be added above the GAF node and then executed by the GAF node with this batch of vertices as input. There must be some information that keeps track of which row from the left side of the join the returned paths correspond to. This is necessary for the NESTED LOOPS join to be able to stitch back together the information from the path (returned by the GAF+suffix side) with the values coming from the left side (the prefix). This capability is typically not readily available by NESTED LOOPS join implementation in existing relation systems.

### Procedural Overview

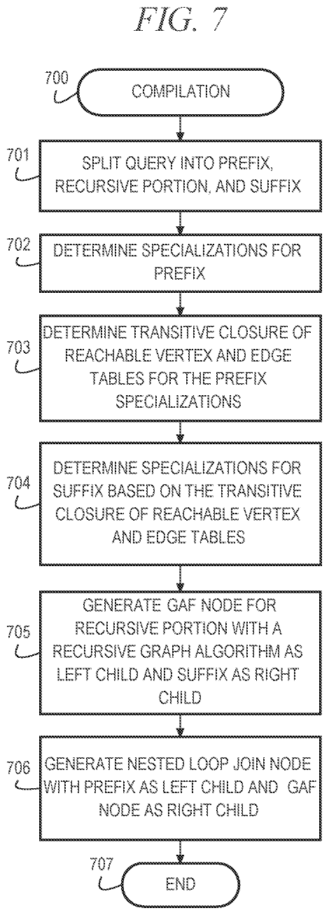

FIG. 7 is a flowchart illustrating operation of relational database system for compiling an unbounded RPQ to form a relational execution tree in accordance with an illustrative embodiment. Operation begins (block 700), and the relational database system splits the query into a prefix portion, a recursive portion, and a suffix portion (block 701). The relational database system determines a set of specializations for the prefix portion (block 702). Then, the relational database system determines transitive closure of reachable vertex and edge tables for the prefix specializations (block 703).

The relational database system determines a set of specializations for the suffix based on the transitive closure of reachable vertex and edge tables (block 704). The relational database system then generates a GAF node for the recursive portion with a recursive graph algorithm as the left child and the suffix portion as the right child (block 705). The relational database system generates a NESTED LOOPS join node with the prefix as the left child and the GAF node as the right child (block 706). Thereafter, operation ends (block 707).

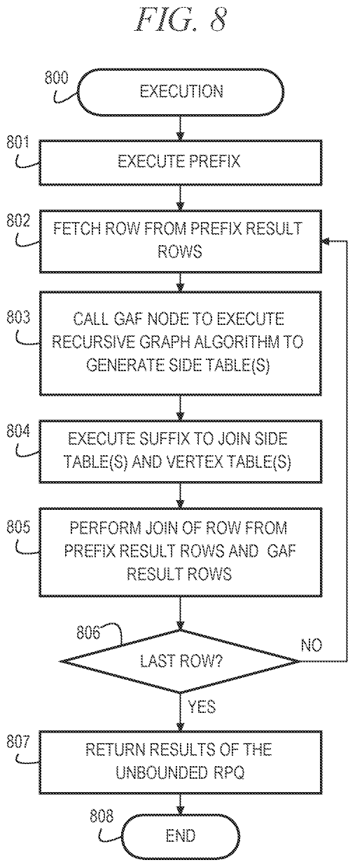

FIG. 8 is a flowchart illustrating operation of a relational database system for executing a relational execution tree for an unbounded RPQ in accordance with an illustrative embodiment. Operation begins (block 800), and relational database system calls the NESTED LOOPS join node of the relational execution tree, which starts execution of the prefix (block 801). The NESTED LOOPS join node then fetches one row from the prefix result rows (block 802) and calls the GAF node to execute the recursive graph algorithm to generate one or more side tables (block 803). The GAF node starts execution of the suffix to join the side tables and one or more vertex tables (block 804).

The NESTED LOOPS join node performs a join of the row from the prefix result rows and the GAF result rows (block 805) and returns results (block 806). The algorithm determines whether the current prefix row is the last row in the prefix result rows (block 807). If the current row is not the last row (block 807:NO), then operation returns to block 802 to fetch the next row from the prefix result rows. If the current row is the last row (block 807:YES), then operation ends (block 808).

### DBMS Overview

A database management system (DBMS) manages a database. A DBMS may comprise one or more database servers. A database comprises database data and a database dictionary that are stored on a persistent memory mechanism, such as a set of hard disks. Database data may be stored in one or more collections of records. The data within each record is organized into one or more attributes. In relational DBMSs, the collections are referred to as tables (or data frames), the records are referred to as records, and the attributes are referred to as attributes. In a document DBMS (“DOCS”), a collection of records is a collection of documents, each of which may be a data object marked up in a hierarchical-markup language, such as a JSON object or XML document. The attributes are referred to as JSON fields or XML elements. A relational DBMS may also store hierarchically marked data objects; however, the hierarchically marked data objects are contained in an attribute of record, such as JSON typed attribute.

Users interact with a database server of a DBMS by submitting to the database server commands that cause the database server to perform operations on data stored in a database. A user may be one or more applications running on a client computer that interacts with a database server. Multiple users may also be referred to herein collectively as a user.

A database command may be in the form of a database statement that conforms to a database language. A database language for expressing the database commands is the Structured Query Language (SQL). There are many different versions of SQL; some versions are standard and some proprietary, and there are a variety of extensions. Data definition language (“DDL”) commands are issued to a database server to create or configure data objects referred to herein as database objects, such as tables, views, or complex data types. SQL/XML is a common extension of SQL used when manipulating XML data in an object-relational database. Another database language for expressing database commands is Spark™ SQL, which uses a syntax based on function or method invocations.

In a DOCS, a database command may be in the form of functions or object method calls that invoke CRUD (Create Read Update Delete) operations. An example of an API for such functions and method calls is MQL (MondoDB™ Query Language). In a DOCS, database objects include a collection of documents, a document, a view, or fields defined by a JSON schema for a collection. A view may be created by invoking a function provided by the DBMS for creating views in a database.

Changes to a database in a DBMS are made using transaction processing. A database transaction is a set of operations that change database data. In a DBMS, a database transaction is initiated in response to a database command requesting a change, such as a DML command requesting an update, insert of a record, or a delete of a record or a CRUD object method invocation requesting to create, update or delete a document. DML commands and DDL specify changes to data, such as INSERT and UPDATE statements. A DML statement or command does not refer to a statement or command that merely queries database data. Committing a transaction refers to making the changes for a transaction permanent.

Under transaction processing, all the changes for a transaction are made atomically. When a transaction is committed, either all changes are committed, or the transaction is rolled back. These changes are recorded in change records, which may include redo records and undo records. Redo records may be used to reapply changes made to a data block. Undo records are used to reverse or undo changes made to a data block by a transaction.

An example of such transactional metadata includes change records that record changes made by transactions to database data. Another example of transactional metadata is embedded transactional metadata stored within the database data, the embedded transactional metadata describing transactions that changed the database data.

Undo records are used to provide transactional consistency by performing operations referred to herein as consistency operations. Each undo record is associated with a logical time. An example of logical time is a system change number (SCN). An SCN may be maintained using a Lamporting mechanism, for example. For data blocks that are read to compute a database command, a DBMS applies the needed undo records to copies of the data blocks to bring the copies to a state consistent with the snap-shot time of the query. The DBMS determines which undo records to apply to a data block based on the respective logical times associated with the undo records.

In a distributed transaction, multiple DBMSs commit a distributed transaction using a two-phase commit approach. Each DBMS executes a local transaction in a branch transaction of the distributed transaction. One DBMS, the coordinating DBMS, is responsible for coordinating the commitment of the transaction on one or more other database systems. The other DBMSs are referred to herein as participating DBMSs.

A two-phase commit involves two phases, the prepare-to-commit phase, and the commit phase. In the prepare-to-commit phase, branch transaction is prepared in each of the participating database systems. When a branch transaction is prepared on a DBMS, the database is in a “prepared state” such that it can guarantee that modifications executed as part of a branch transaction to the database data can be committed. This guarantee may entail storing change records for the branch transaction persistently. A participating DBMS acknowledges when it has completed the prepare-to-commit phase and has entered a prepared state for the respective branch transaction of the participating DBMS.

In the commit phase, the coordinating database system commits the transaction on the coordinating database system and on the participating database systems. Specifically, the coordinating database system sends messages to the participants requesting that the participants commit the modifications specified by the transaction to data on the participating database systems. The participating database systems and the coordinating database system then commit the transaction.

On the other hand, if a participating database system is unable to prepare or the coordinating database system is unable to commit, then at least one of the database systems is unable to make the changes specified by the transaction. In this case, all of the modifications at each of the participants and the coordinating database system are retracted, restoring each database system to its state prior to the changes.

A client may issue a series of requests, such as requests for execution of queries, to a DBMS by establishing a database session. A database session comprises a particular connection established for a client to a database server through which the client may issue a series of requests. A database session process executes within a database session and processes requests issued by the client through the database session. The database session may generate an execution plan for a query issued by the database session client and marshal slave processes for execution of the execution plan.

The database server may maintain session state data about a database session. The session state data reflects the current state of the session and may contain the identity of the user for which the session is established, services used by the user, instances of object types, language and character set data, statistics about resource usage for the session, temporary variable values generated by processes executing software within the session, storage for cursors, variables, and other information.

A database server includes multiple database processes. Database processes run under the control of the database server (i.e., can be created or terminated by the database server) and perform various database server functions. Database processes include processes running within a database session established for a client.

A database process is a unit of execution. A database process can be a computer system process or thread or a user-defined execution context such as a user thread or fiber. Database processes may also include “database server system” processes that provide services and/or perform functions on behalf of the entire database server. Such database server system processes include listeners, garbage collectors, log writers, and recovery processes.

A multi-node database management system is made up of interconnected computing nodes (“nodes”), each running a database server that shares access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system can be allocated to running a particular database server's software. Each combination of the software and allocation of resources from a node is a server that is referred to herein as a “server instance” or “instance.” A database server may comprise multiple database instances, some or all of which are running on separate computers, including separate server blades.

A database dictionary may comprise multiple data structures that store database metadata. A database dictionary may, for example, comprise multiple files and tables. Portions of the data structures may be cached in main memory of a database server.

When a database object is said to be defined by a database dictionary, the database dictionary contains metadata that defines properties of the database object. For example, metadata in a database dictionary defining a database table may specify the attribute names and data types of the attributes, and one or more files or portions thereof that store data for the table. Metadata in the database dictionary defining a procedure may specify a name of the procedure, the procedure's arguments and the return data type, and the data types of the arguments, and may include source code and a compiled version thereof.

A database object may be defined by the database dictionary, but the metadata in the database dictionary itself may only partly specify the properties of the database object. Other properties may be defined by data structures that may not be considered part of the database dictionary. For example, a user-defined function implemented in a JAVA class may be defined in part by the database dictionary by specifying the name of the user-defined function and by specifying a reference to a file containing the source code of the Java class (i.e., .java file) and the compiled version of the class (i.e., .class file).

Native data types are data types supported by a DBMS “out-of-the-box.” Non-native data types, on the other hand, may not be supported by a DBMS out-of-the-box. Non-native data types include user-defined abstract types or object classes. Non-native data types are only recognized and processed in database commands by a DBMS once the non-native data types are defined in the database dictionary of the DBMS, by, for example, issuing DDL statements to the DBMS that define the non-native data types. Native data types do not have to be defined by a database dictionary to be recognized as valid data types and to be processed by a DBMS in database statements. In general, database software of a DBMS is programmed to recognize and process native data types without configuring the DBMS to do so by, for example, defining a data type by issuing DDL statements to the DBMS.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

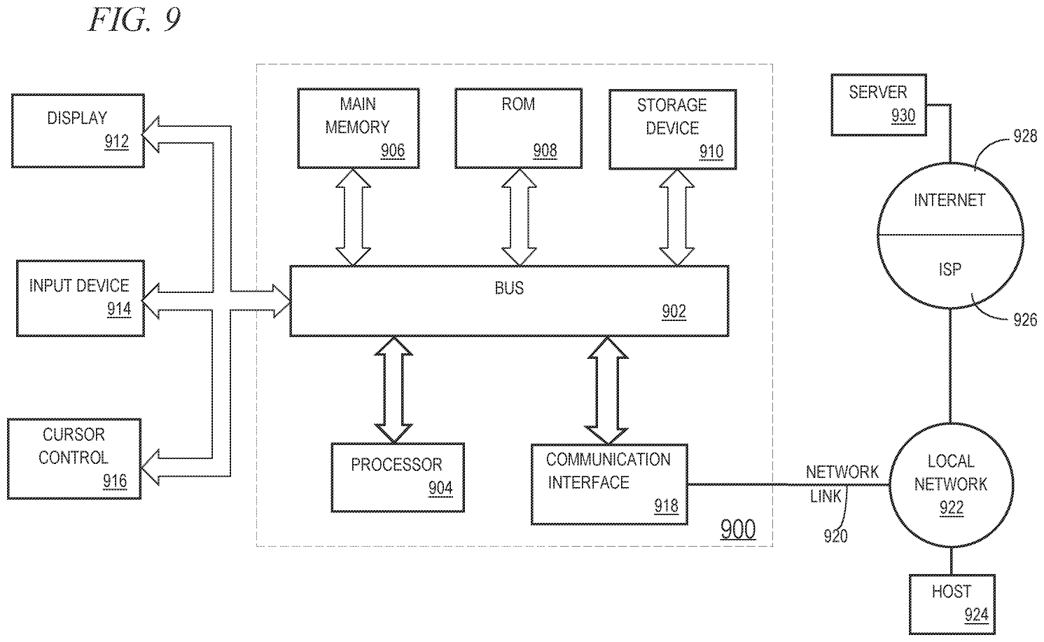

For example, FIG. 9 is a block diagram that illustrates a computer system 900 upon which aspects of the illustrative embodiments may be implemented. Computer system 900 includes a bus 902 or other communication mechanism for communicating information, and a hardware processor 904 coupled with bus 902 for processing information. Hardware processor 904 may be, for example, a general-purpose microprocessor.

Computer system 900 also includes a main memory 906, such as a random-access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or solid-state drive is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic, or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world-wide packet data communication network now commonly referred to as the “Internet” 928. Local network 922 and Internet 928 both use electrical, electromagnetic, or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### Software Overview

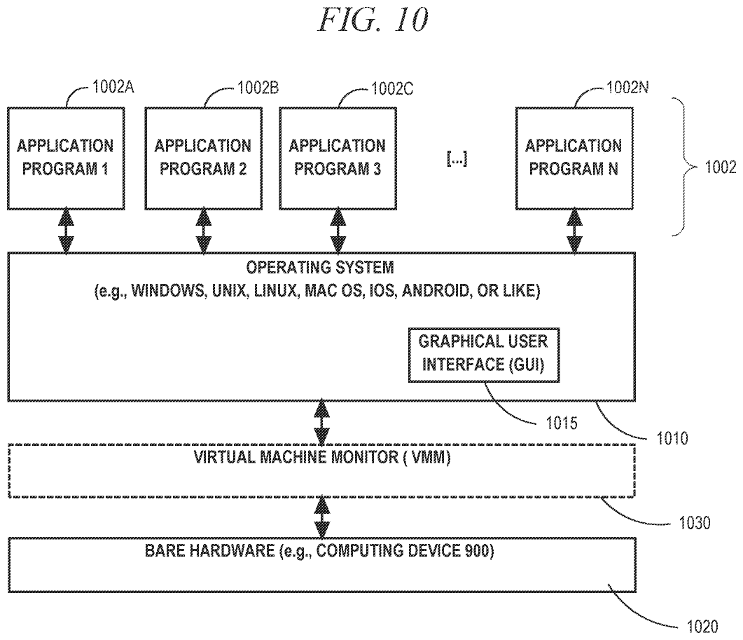

FIG. 10 is a block diagram of a basic software system 1000 that may be employed for controlling the operation of computer system 900. Software system 1000 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computer system 900. Software system 1000, which may be stored in system memory (RAM) 906 and on fixed storage (e.g., hard disk or flash memory) 910, includes a kernel or operating system (OS) 1010.

The OS 1010 manages low-level aspects of computer operation, including managing execution of processes, memory allocation, file input and output (I/O), and device I/O. One or more application programs, represented as 1002A, 1002B, 1002C . . . 1002N, may be “loaded” (e.g., transferred from fixed storage 910 into memory 906) for execution by system 1000. The applications or other software intended for use on computer system 900 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 904) of computer system 900. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 900.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system to run as if it is running on the bare hardware 1020 of computer system 1000 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
a relational database system compiling an unbounded regular path graph query into a relational execution tree, wherein:
the unbounded regular path graph query is issued against a graph having vertices and edges stored in a plurality of tables, and
compiling the unbounded regular path graph query comprises:
splitting the unbounded regular path graph query into a prefix portion, a recursive portion, and a suffix portion;
generating a graph algorithm function (GAF) node for the recursive portion in the relational execution tree;
generating a nested loops join node in the relational execution tree, wherein:
the nested loops join node has a left child comprising the prefix portion and a right child comprising the GAF node, and
the GAF node has a left child comprising a recursive graph algorithm and a right node comprising the suffix portion; and
the relational database system executing the relational execution tree, wherein executing the relational execution tree generates a result for the unbounded regular path graph query,
wherein the method is performed by one or more computing devices.

2. The method of claim 1, wherein compiling the unbounded regular path graph query further comprises:
determining a set of one or more prefix specializations for the prefix portion of the unbounded regular path graph query;
determining a transitive closure of reachable vertex and edge tables for the one or more prefix specializations; and
determining a set of one or more suffix specializations for the suffix portion of the unbounded regular path graph query based on the transitive closure of reachable vertex and edge tables.

3. The method of claim 2, wherein the transitive closure is used to reduce the set of vertex and edge tables considered in the recursive graph algorithm.

4. The method of claim 2, wherein compiling the unbounded regular path graph query further comprises translating the set of one or more prefix specializations and the set of one or more suffix specializations to SQL.

5. The method of claim 1, wherein executing the relational execution tree comprises:
executing the prefix portion to generate a set of prefix result rows, wherein each row in the set of prefix result rows represents a pattern in the graph that matches the prefix portion of the unbounded regular path graph query;
executing the nested loops join node by:
fetching a given row from the set of prefix result rows;
calling the GAF node to execute the recursive graph algorithm based on a starting vertex from the given row to generate a set of recursive graph algorithm result rows, wherein each row in the set of recursive graph algorithm result rows represents a vertex that is reachable from the starting vertex and matches a starting vertex of the suffix portion, and to execute the suffix portion to generate a set of GAF result rows;
fetching the set of GAF result rows; and
performing a join of the set of prefix result rows and the set of GAF result rows.

6. The method of claim 5, wherein:
the graph comprises one or more vertex tables,
each execution of the recursive graph algorithm generates a side table for each of the one or more vertex tables to form one or more side tables, and
executing the suffix portion reads from the one or more side tables for path and destination information.

7. The method of claim 6, wherein the one or more side tables comprise one or more cursor duration temporary tables (CDTs).

8. The method of claim 6, wherein executing the suffix portion comprises one or more joins between the one or more side tables and vertex or edge tables of the graph.

9. The method of claim 6, wherein each of the one or more side tables stores a row for each step in a path that reaches a destination vertex from the starting vertex.

10. The method of claim 9, wherein:
each row of a given side table stores path information comprising a property value of a vertex or edge for a corresponding step, and
the suffix portion performs an aggregation of the property values of the steps of a path from the starting vertex to the destination vertex.

11. The method of claim 6, wherein the unbounded regular path graph query is a reachability query and wherein each of the one or more side tables stores a row for each destination vertex that is reachable from the starting vertex.

12. The method of claim 5, wherein:
the graph is homogeneous,
each execution of the recursive graph algorithm generates a row-source,
executing the nested loops join node further comprises executing the suffix portion, and
executing the suffix portion reads from the row-source for path and destination information.

13. The method of claim 1, wherein the unbounded regular path graph query is a shortest path query and wherein the recursive graph algorithm is a breadth first search (BFS) algorithm.

14. The method of claim 13, wherein the BFS algorithm performs batch expand by expanding more than one vertex in each query.

15. The method of claim 1, wherein the unbounded regular path graph query is a cheapest path query and wherein the recursive graph algorithm is a Dijkstra algorithm.

16. One or more non-transitory storage media storing instructions which, when executed by one or more computing devices, cause:
a relational database system compiling an unbounded regular path graph query into a relational execution tree, wherein:
the unbounded regular path graph query is issued against a graph having vertices and edges stored in a plurality of tables, and
compiling the unbounded regular path graph query comprises:
splitting the unbounded regular path graph query into a prefix portion, a recursive portion, and a suffix portion;
generating a graph algorithm function (GAF) node for the recursive portion in the relational execution tree;
generating a nested loops join node in the relational execution tree, wherein:
the nested loops join node has a left child comprising the prefix portion and a right child comprising the GAF node, and
the GAF node has a left child comprising a recursive graph algorithm and a right node comprising the suffix portion; and
the relational database system executing the relational execution tree, wherein executing the relational execution tree generates a result for the unbounded regular path graph query.

17. The one or more non-transitory storage media of claim 16, wherein compiling the unbounded regular path graph query further comprises:
determining a set of one or more prefix specializations for the prefix portion of the unbounded regular path graph query;
determining a transitive closure of reachable vertex and edge tables for the one or more prefix specializations; and
determining a set of one or more suffix specializations for the suffix portion of the unbounded regular path graph query based on the transitive closure of reachable vertex and edge tables.

18. The one or more non-transitory storage media of claim 16, wherein executing the relational execution tree comprises:
executing the prefix portion to generate a set of prefix result rows, wherein each row in the set of prefix result rows represents a pattern in the graph that matches the prefix portion of the unbounded regular path graph query;
executing the nested loops join node by:
fetching a given row from the set of prefix result rows;
calling the GAF node to execute the recursive graph algorithm based on a starting vertex from the given row to generate a set of recursive graph algorithm result rows, wherein each row in the set of recursive graph algorithm result rows represents a vertex that is reachable from the starting vertex and matches a starting vertex of the suffix portion;
fetching the set of recursive graph algorithm result rows; and
performing a join of the set of prefix result rows and the set of recursive graph algorithm result rows.

19. The one or more non-transitory storage media of claim 18, wherein:
the graph comprises one or more vertex tables,
each execution of the recursive graph algorithm generates a side table for each of the one or more vertex tables to form one or more side tables, and
executing the suffix portion reads from the one or more side tables for path and destination information.

20. The one or more non-transitory storage media of claim 18, wherein:
the graph is homogoneous,
each execution of the recursive graph algorithm generates a row-source,
executing the nested loops join node further comprises executing the suffix portion, and
executing the suffix portion reads from the row-source for path and destination information.
